(19) United States
(12) Patent Application Publication
(10) Pub. No.: US 2009/0310171 A1
(43) Pub. Date: Dec. 17, 2009

(54) PRINTING INSTRUCTING APPARATUS, PRINTING INSTRUCTING METHOD, AND RECORDING MEDIUM

(75) Inventor: Yuko Onoda, Chiyoda-ku (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/407,304

(22) Filed: Mar. 19, 2009

(30) Foreign Application Priority Data
Jun. 11, 2008 (JP) 2008-152410

(51) Int. Cl. G06F 15/00

(52) U.S. Cl. 358/1.15

(57) ABSTRACT

Disclosed is a, printing instructing apparatus to instruct printing in an image forming apparatus, the apparatus including: a storage section to store a plurality of pieces of printing setting information, each piece of the information including a plurality of printing conditions regarding a plurality of setting items, respectively; a display section; an operation section to receive a selection of a piece of printing setting information to be applied at the time of printing execution among the plurality of pieces of printing setting information stored in the storage section; and a control section to obtain the selected printing setting information from the storage section, to respectively compare the printing conditions of the setting items in the selected printing setting information with those in reference printing setting information, and to recognizably display information indicating a difference between the selected printing setting information and the reference printing setting information in the display section.

### CROSS-REFERENCE TO RELATED APPLICATION

The present U.S. patent application claims a priority under the Paris Convention of Japanese patent application No. 2008-152410 filed on Jun. 11, 2008, which shall be a basis of correction of an incorrect translation.

### BACKGROUND

1. Field of the Invention

The present invention relates to a printing instructing apparatus, a printing instructing method, and a recording medium.

2. Description of Related Art

In recent years, a system for controlling an image forming apparatus, such as a printer, connected through a communication network from a personal computer (PC) in which a printer driver is installed, has become common. For example, a user can set the printing condition of each of setting items, such as a sheet size, a sheet type, and a number of sets, on a printer driver. By saving printing setting information indicating such printing conditions, it becomes possible to perform image formation by applying the same printing conditions as those once set again.

If the set content for printing that a user has set on a printer driver is desired to be checked, then which condition has been set is checked on a printing setting screen with respect to each of the setting items, but it is difficult to recognize which condition has been changed. Accordingly, there has been proposed a printer driver which compares the initial content of setting items for printing indicating the printing conditions of a printer with the presently set content, and displays the setting item that has been changed from the initial setting thereof and the changed set content thereof with respect to the changed setting item (see Japanese Patent Application Laid-Open Publication No. 2003-216362).

However, it is difficult to check which setting item includes a difference between the printing setting information that a user has selected and reference printing setting information such as a default setting or a present setting in case of using the printing setting information that has already saved. Moreover, if it has passed a long time since printing setting information has been saved, or if the printing setting information saved by another user is used, there is a case where a user does not grasp the whole setting item. In such a case, it is difficult to know which item is changed in the case of applying the saved printing setting information, and consequently it is apprehended that a setting change that is not intended by the user is performed.

### SUMMARY

The present invention is directed to enable the information of the differences of printing setting information and reference printing setting information at the time of selecting the printing setting information to be applied at the time of printing execution from a plurality of pieces of printing setting information that has been already stored.

In order to achieve the above objects, the printing instructing apparatus in which one aspect of the present invention is reflected is a printing instructing apparatus to instruct printing in an image forming apparatus, and includes: a storage section to store a plurality of pieces of printing setting information, each piece of the printing setting information including a plurality of printing conditions regarding a plurality of setting items, respectively; a display section; an operation section to receive a selection of a piece of printing setting information to be applied at the time of printing execution among the plurality of pieces of printing setting information stored in the storage section; and a control section to obtain the selected printing setting information from the storage section, to respectively compare the printing conditions of the setting items in the selected printing setting information with those in reference printing setting information, and to recognizably display information indicating a difference between the selected printing setting information and the reference printing setting information in the display section.

In the printing instructing apparatus, preferably, the control section displays in the display section only a setting item where the selected printing setting information and the reference printing setting information are different from each other among the setting items of the selected printing setting information and the reference printing setting information as the information indicating the difference between the selected printing setting information and the reference printing setting information.

In the printing instructing apparatus, preferably, the control section displays the selected printing setting information in the display section by highlighting a setting item where the selected printing setting information and the reference printing setting information are different from each other as the information indicating the difference between the selected printing setting information and the reference printing setting information.

In the printing instructing apparatus, preferably, the reference printing setting information is selected by a user.

In the printing instructing apparatus, preferably, the reference printing setting information is previously determined standard printing setting information.

In the printing instructing apparatus, preferably, the reference printing setting information is presently set printing setting information.

In the printing instructing apparatus, preferably, the operation section further receives a selection of whether to apply the selected printing setting information at the time of the printing execution or not, and the control section judges whether to apply the selected printing setting information at the time of the printing execution or not on the basis of an operation of the operation section after displaying the information indicating the difference between the selected printing setting information and the reference printing setting information recognizably in the display section.

In the printing instructing apparatus, preferably, the control section displays in the display section help information of a setting item where the selected printing setting information and the reference printing setting information are different from each other.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein:

FIG. 1 is a system configuration diagram of an image forming system according to a first embodiment of the present invention;

FIG. 2 is a block diagram showing the functional configuration of a PC;

FIG. 3 is a view showing an example of a registry in a hard disk drive (HDD) in which the names of favorite settings are saved;

FIG. 4 is a view showing an example of a registry in a HDD in which the pieces of printing setting information of favorite settings are saved;

FIG. 5 is a view showing an example of a structure;

FIG. 6 is a view showing an example of the data extracted with respect to each setting item;

FIG. 7 is a view for illustrating a comparison method of a selected favorite setting and a reference setting;

FIG. 8 is a block diagram showing the functional configuration of an image forming apparatus;

FIG. 9 is a, flow chart showing first printing setting processing in the first embodiment;

FIG. 10 is a flow chart showing the first printing setting processing in the first embodiment;

FIG. 11 is a view showing a display example of a printing setting screen;

FIG. 12 is a view showing a display example of an editing screen of favorite settings in the first embodiment;

FIG. 13 is a view showing a display example of a different point displaying screen in the first embodiment;

FIG. 14 is a, flow chart showing printing setting processing in a variation 1;

FIG. 15A is a view showing a display example of a different point displaying screen in a variation 2;

FIG. 15B is a view showing a display example of a help screen;

FIG. 16 is a flow chart showing help display processing in the variation 2;

FIG. 17 is a view showing a display example of an editing screen of favorite settings in a second embodiment;

FIG. 18 is a flow chart showing second printing setting processing in the second embodiment;

FIG. 19 is a view showing a display example of an editing screen of favorite settings in a third embodiment; and

FIG. 20 is a flow chart showing third printing setting processing in the third embodiment.

### DETAILED DESCRIPTION OF THE PREFERRED EMBODIMENT

### First Embodiment

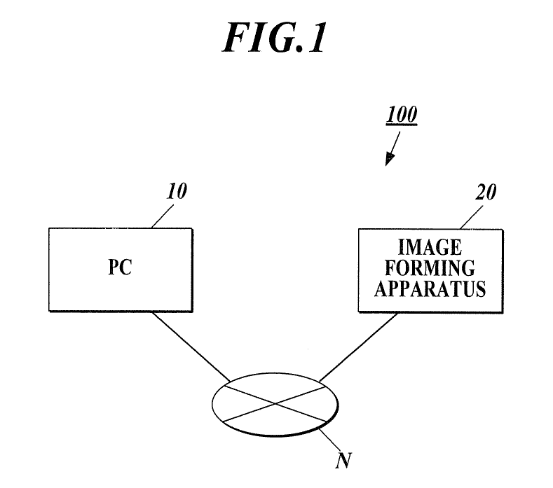

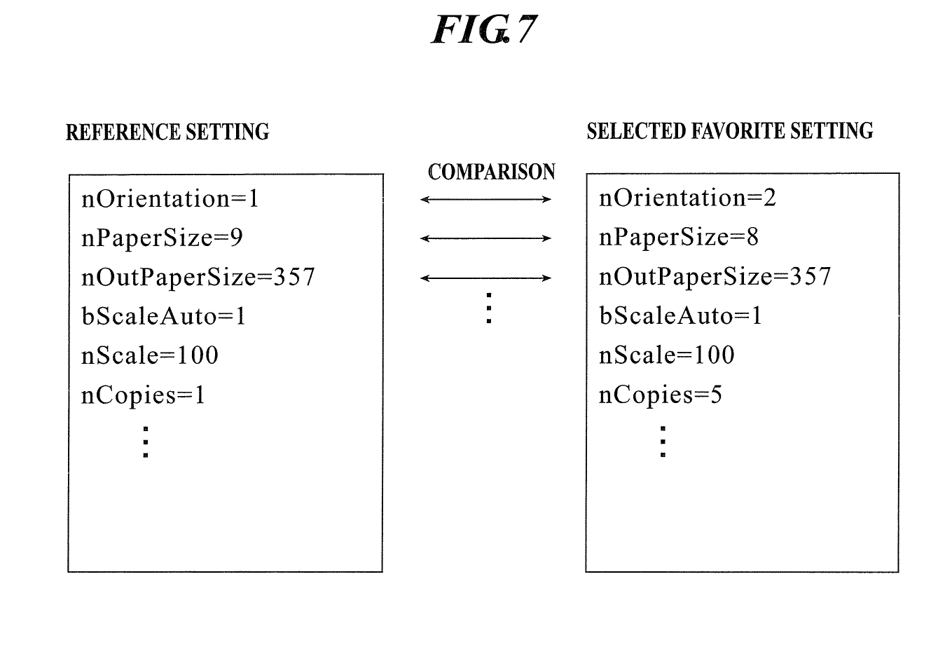

First, a first embodiment of the present invention will be described with reference to FIGS. 1-13.

FIG. 1 shows the system configuration of an image forming system 100. As shown in FIG. 1, the image forming system 100 is composed of a PC 10 as a, printing instructing apparatus and an image forming apparatus 20, and each apparatus is connected to each other in the state capable of performing data communication with each other through a communication network N.

The PC 10 instructs printing in the image forming apparatus 20. A printer driver program is installed in the PC 10. The PC 10 generates a print job including printing setting information indicating printing conditions to be applied at the time of printing execution, image data, and the like by the use of the function of the printer driver, and transmits the generated print job to the image forming apparatus 20.

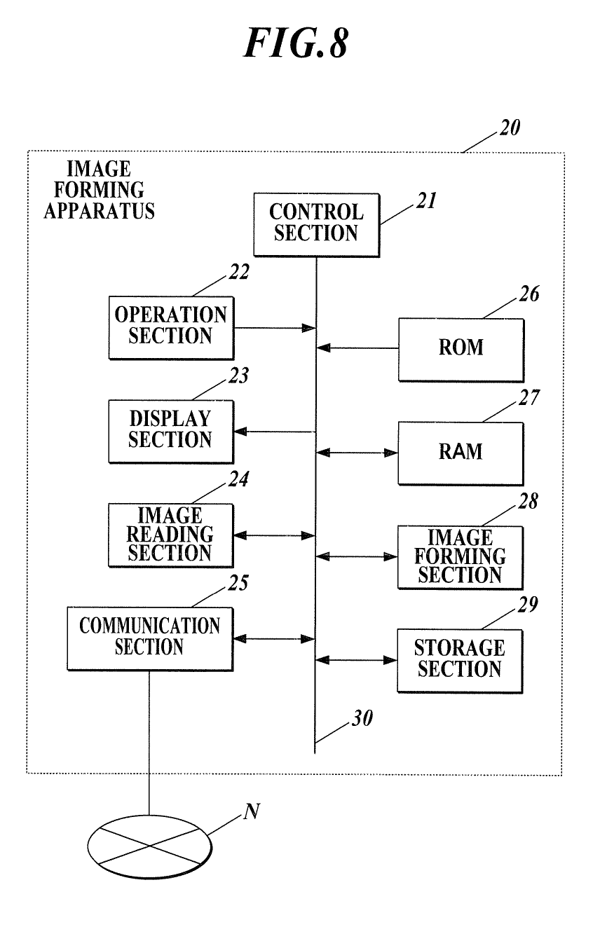

The image forming apparatus 20 is the so-called multi-function peripheral (MFP) equipped with a copying function, an image reading function, and a printer function, and forms an image on a sheet on the basis of the print job transmitted from the PC 10, image data read with an image reading section 24 (see FIG. 8), such as a scanner equipped in the image forming apparatus 20, and the like.

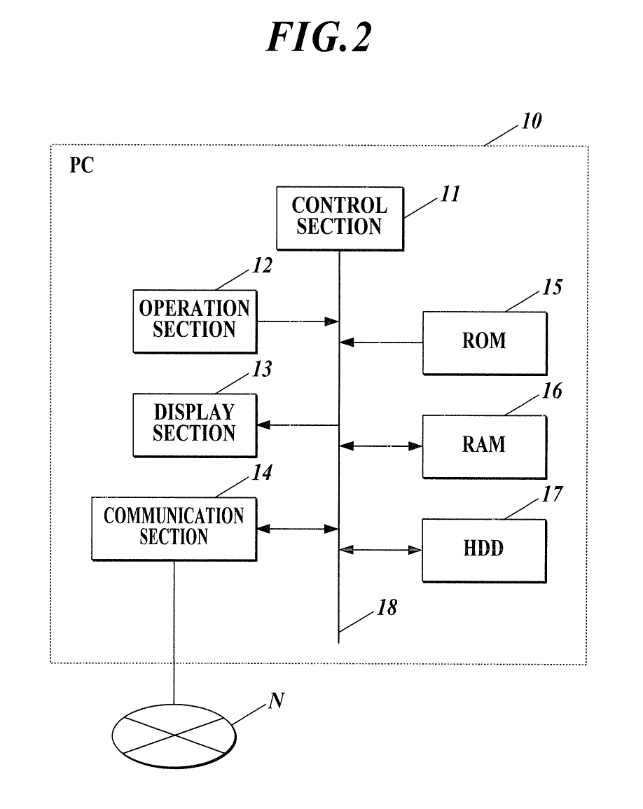

FIG. 2 shows the functional configuration of the PC 10. As shown in FIG. 2, the PC 10 is equipped with a control section 11, an operation section 12, a display section 13, a communication section 14, a, read only memory (ROM) 15, a random access memory (RAM) 16, and a hard disk drive (HDD) 17, and each section is connected with one another with a bus 18.

The control section 11 is composed of a central processing unit (CPU) and the like, and collectively controls the processing operations of each section of the PC 10. To put it concretely, the CPU reads various processing programs stored in the ROM 15 or the HDD 17 and expands the read processing programs in the RAM 16 on the basis of operation signals input from the operation section 12 or instruction signals received with the communication section 14. Then, the CPU performs various kinds of processing in corporation with the programs.

The operation section 12 is composed of a, keyboard including cursor keys, alphabetic keys, various function keys, and the like, and a pointing device, such as a mouse. The operation section 12 outputs the instruction signals input with key operations on the keyboard and mouse operations to the control section 11. For example, the operation section 12 is used at the time of selecting a piece of printing setting information to be applied at the time of printing execution among a plurality of pieces of printing setting information stored in the HDD 17.

The display section 13 is composed of a liquid crystal display (LCD), and displays various display screens and the like in accordance with display signals input from the control section 11.

The communication section 14 is a function section to perform the transmission and reception of data with external equipment, such as the image forming apparatus 20, connected thereto through the communication network N.

The ROM 15 is composed of a nonvolatile semiconductor memory and the like, and stores various processing programs to be executed in the control section 11, various pieces of data, and the like. These various programs are stored in the ROM 15 in the form of readable program codes, and the control section 11 sequentially executes the operations in conformity with the program codes.

The RAM 16 forms a work area in which various processing programs to be executed by the control section 11 and the data pertaining to these programs are temporarily stored.

The HDD 17 is a storage apparatus to store various programs, such as a printer driver program, set data, image data, and the like. Moreover, a plurality of pieces of printing setting information is stored in the HDD 17 as a “favorite setting,” each of the pieces of printing setting information is stored correspondingly to each of a plurality of setting items (such as a document orientation, a document size, a sheet size, zoom, a feeding tray, a sheet type, and the number of sets). The “favorite setting” means the printing setting information saved by a user for a later use.

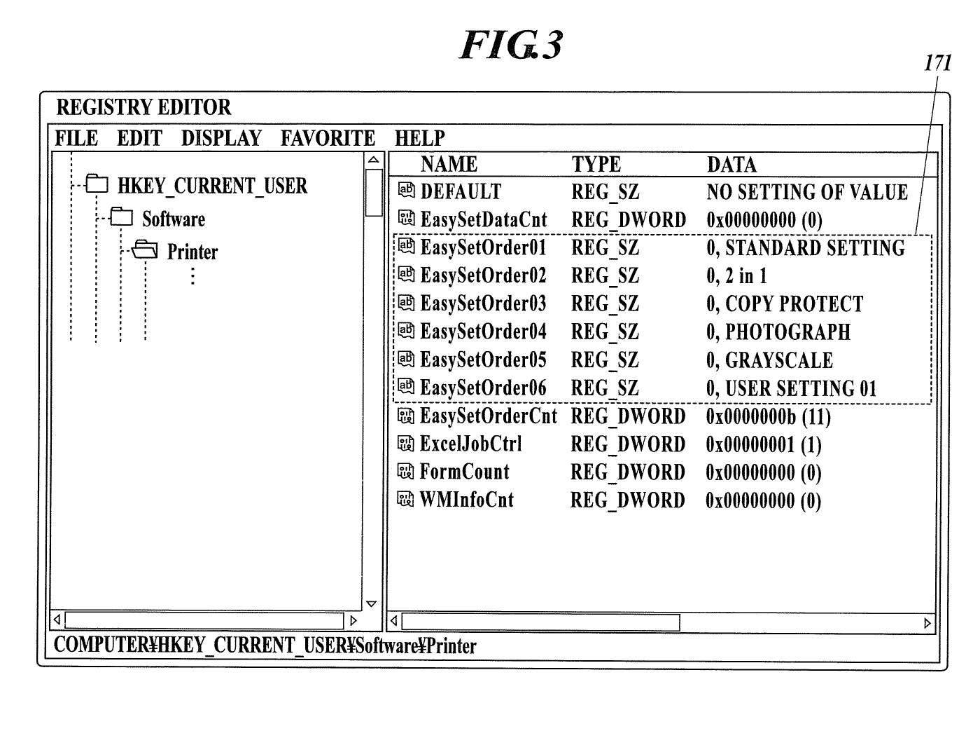

FIG. 3 shows an example of a registry, saving the names of the favorite settings, within the HDD 17. In the example shown in FIG. 3, “standard setting,” “2 in 1,” “copy protect,” “picture,” “grayscale,” and “user setting 01” are stored in a registry region 171 as the names of the favorite settings. The “standard setting” means standard printing setting information, which is previously determined as default values of the printing conditions.

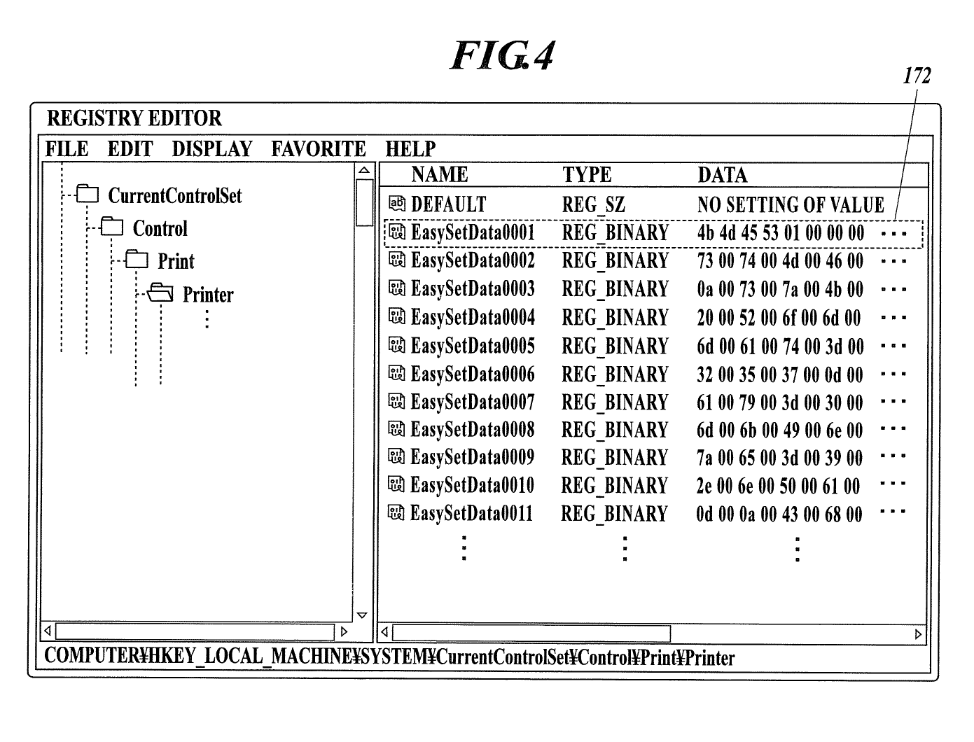

FIG. 4 shows an example of the registry saving the printing setting information of favorite settings within the HDD 17. The printing setting information corresponding to each of the favorite settings is stored in a registry region 172 and the like.

The control section 11 reads a printer driver program from the HDD 17 to expand the read printer driver program in the RAM 16, and generates a print job to be transmitted to the image forming apparatus 20 in corporation with the printer driver program to instruct the printing in the image forming apparatus 20.

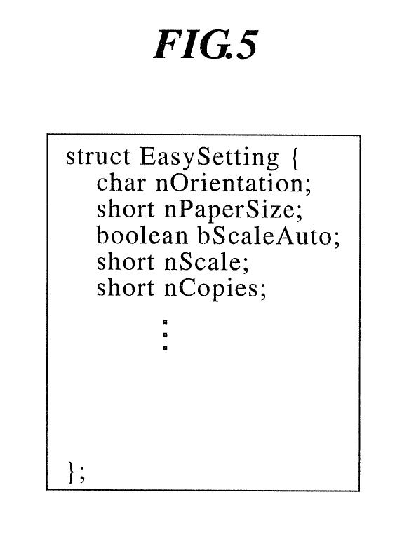

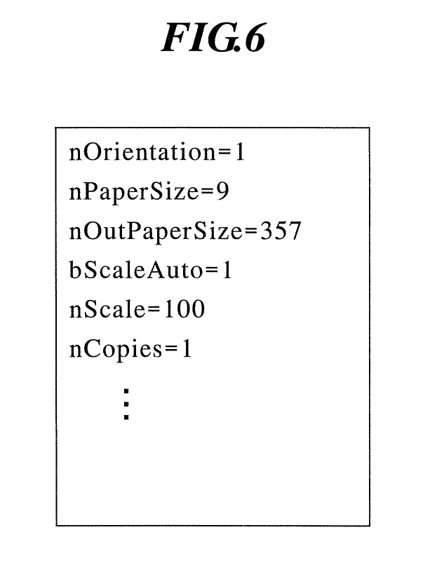

The control section 11 obtains the printing setting information that has been selected through the operation section 12 and is to be applied at the time of printing execution from the HDD 17. To put it concretely, the control section 11 reads the printing setting information selected from the registry region 172 or the like, shown in FIG. 4, and sets the read data into the structure shown in FIG. 5 to extract data with respect to each of the setting items as shown in FIG. 6. The phrase “nOrientation” denotes a document orientation; the phrase “nSheetSize” denotes a document size; the phrase “nOutSheetSize” denotes a sheet size; the phrase “bScaleAuto” denotes zoom automatic setting; the phrase “nScale” denotes a magnification ratio; and the phrase “nCopies” denotes a number of sets.

The control section 11 compares selected printing setting information (hereinafter also referred to as a selected favorite setting) and reference printing setting information (hereinafter referred to as a reference setting) in each of the setting items. To put it concretely, the control section 11 compares the printing setting information of both the selected favorite setting and the reference setting in each of the setting items to judge whether both agree with each other or whether both are different from each other. The reference setting is made to be selectable by a user from a plurality of pieces of printing setting information prepared in advance, and it is also possible to select the presently set printing setting information as the reference setting.

The control section 11 displays the information indicating the difference between the selected favorite setting and the reference setting on the display section 13 in the state capable of being recognized. To put it concretely, the control section 11 displays only the setting items the selected favorite setting and reference setting of which are different from each other on the display section 13 as the information indicating the difference between the selected favorite setting and the reference setting.

The control section 11 judges whether the selected favorite setting is applied at the time of printing execution or not on the basis of an operation of the operation section 12 after displaying the information indicating the difference between the selected favorite setting and the reference setting to be recognizably on the display section 13.

FIG. 8 shows the functional configuration of the image forming apparatus 20. As shown in FIG. 8, the image forming apparatus 20 is equipped with a control section 21, an operation section 22, a display section 23, the image reading section 24, a communication section 25, a ROM 26, a RAM 27, an image forming section 28, and a storage section 29, and each section is connected to one another through a bus 30.

The control section 21 is composed of a CPU and the like, and collectively controls the processing operation of each section of the image forming apparatus 20. To put it concretely, the CPU reads various processing programs stored in the ROM 26 and expands the read processing programs into the RAM 27 on the basis of operation signals input from the operation section 22 or instruction signals received with the communication section 25. Then, the CPU performs various kinds of processing in corporation with the programs.

The operation section 22 includes various keys, such as numeric keys, a start key, and a reset key, and outputs a depression signal of a depressed key to the control section 21. Moreover, the operation section 22 is equipped with a touch panel formed with the display section 23 integrally, and detects the position on the touch panel, on which position the tip of a finger of a user, a touch pen, or the like abuts to output a positional signal to the control section 21.

The display section 23 is composed of an LCD, and displays an input instruction and data from the operation section 22 in conformity with the instruction of a display signal input from the control section 21.

The image reading section 24 is the so-called scanner, which reads a document image to generate image data. The image reading section 24 is equipped with a platen glass plate, on which a document is placed, and a scanning optical system to scan a document image on the platen glass. The scanning optical system performs the image formation of the document image on a charge coupled device (CCD) image sensor. The image reading section 24 performs the A/D conversion of the image signal generated on the basis of the document image read with the CCD image sensor to generate image data.

The communication section 25 is a function section to perform the transmission and reception of data with external equipment, such as the PC 10, connected thereto through the communication network N.

The ROM 26 is composed of a nonvolatile semiconductor memory and the like, and stores various processing programs to be executed in the control section 21, various pieces of data, and the like. These various programs are stored in the form of readable program codes, and the control section 21 sequentially executes the operations in conformity with the program codes.

The RAM 27 forms a work area in which various processing programs to be executed by the control section 21 and the data pertaining to these programs are temporarily stored.

The image forming section 28 is a function section including components necessary for forming an image by means of an image forming process, such as an electrophotographic printing system, an electrostatic printing system, and a thermal transfer printing system. For example, the image forming section 28 is equipped with a photosensitive body, a transfer belt, a fixing device, various conveying belts, and the like. The image forming section 28 forms an image on a sheet on the basis of the image data generated by the image reading section 24 or the image data received with the communication section 25 in conformity with an instruction of the control section 21.

The storage section 29 is a storage apparatus, such as a hard disk, and stores the image data read with the image reading section 24, the data of the print job received from the PC 10 with the communication section 25, and the like.

Next, the operation of the image forming apparatus 100 will be described.

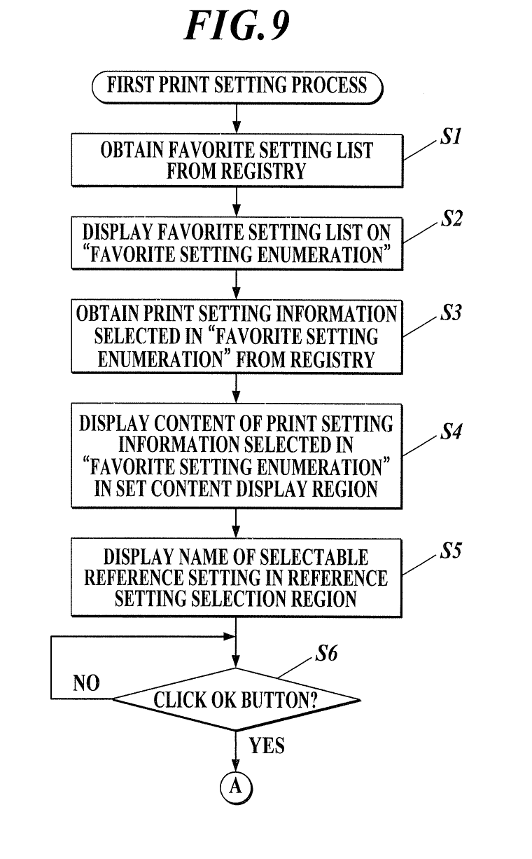

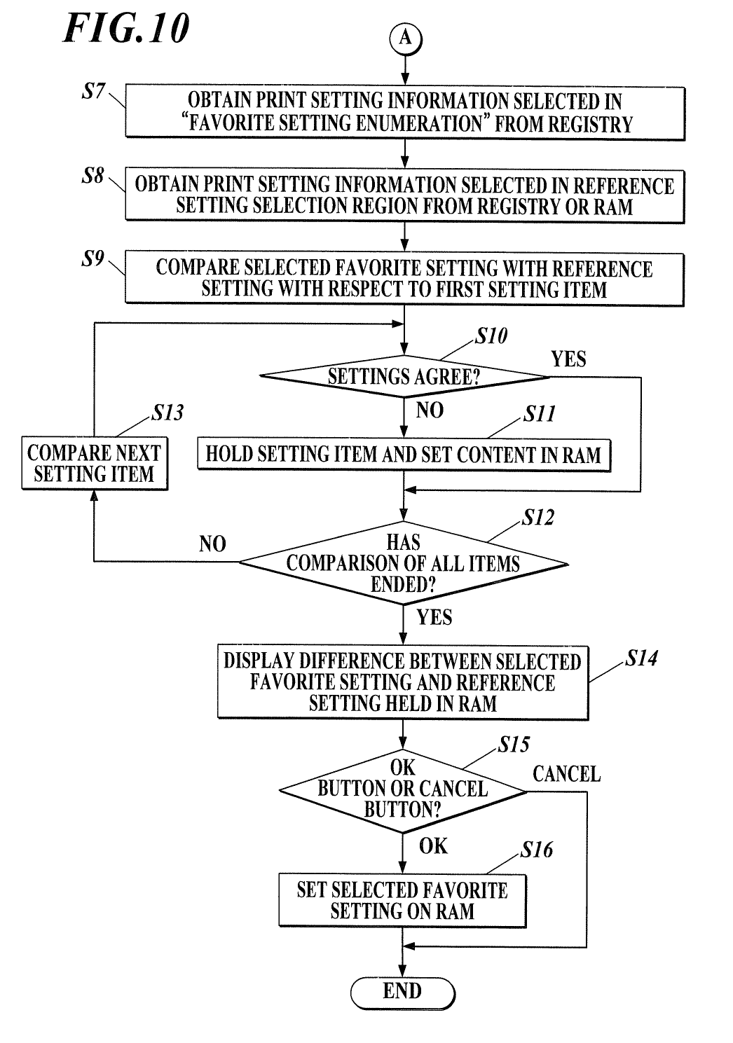

FIGS. 9 and 10 are flow charts showing first printing setting processing which is executed in the PC 10. This processing is realized by software processing by the corporation of the CPU of the control section 11 and a printer driver program stored in the HDD 17.

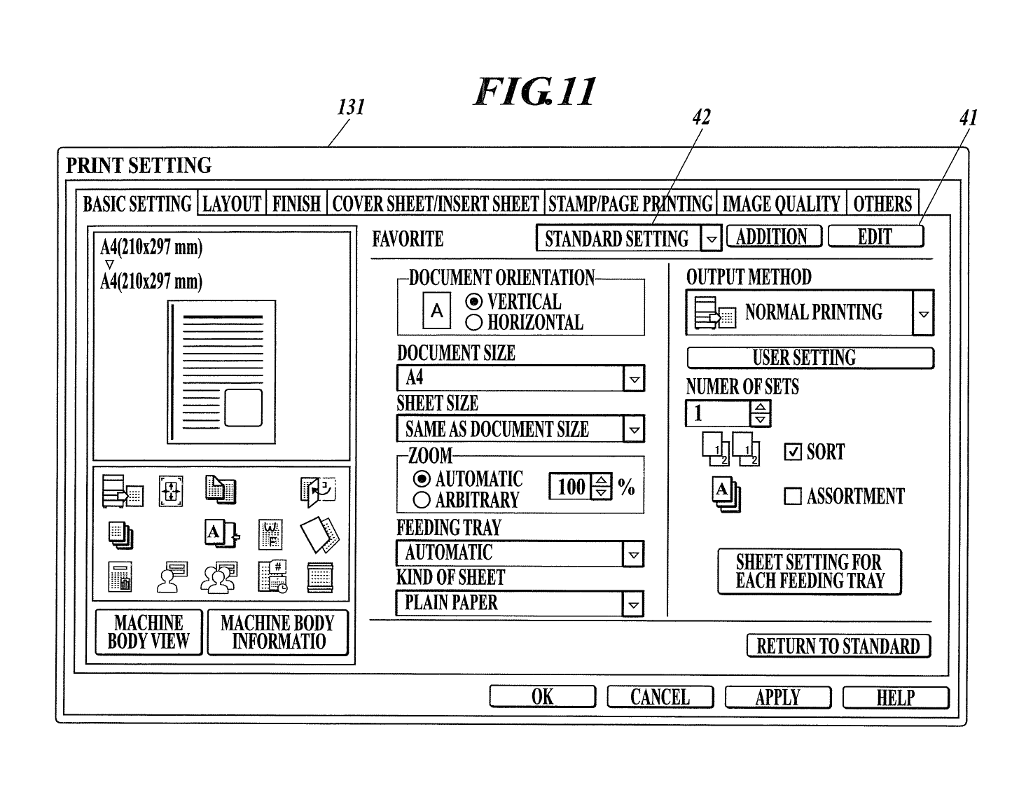

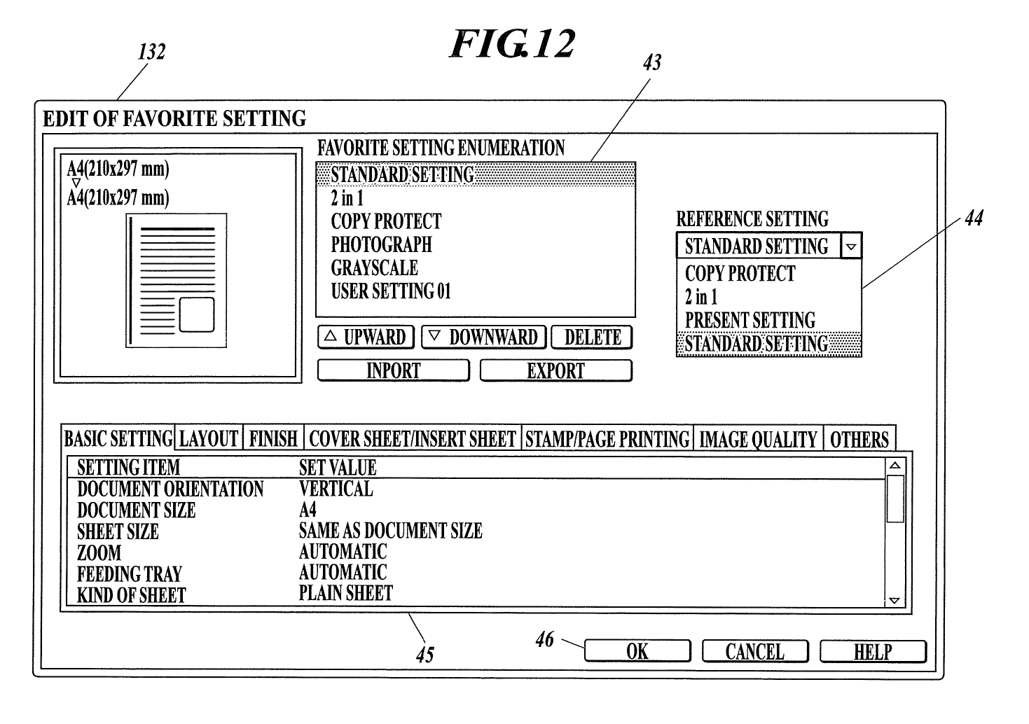

FIG. 11 shows an example of a printing setting screen 131 displayed on the display section 13 of the PC 10. The printing setting screen 131 is displayed on the display section 13 every setting time of the printing conditions in the image forming apparatus 20 to each of the setting items, such as the document orientation, the document size, the sheet size, the zoom automatic setting, the magnification ratio, the feeding tray, the sheet type, the output method, and the number of sets. When an editing button 41 is clicked on the printing setting screen 131 by an operation of the mouse in the operation section 12, an editing screen 132 of the favorite settings shown in FIG. 12 is displayed in the display section 13.

As shown in FIG. 12, the editing screen 132 of the favorite settings includes a “favorite setting enumeration” 43, a reference setting selection region 44, a set content display region 45, an OK button 46, and the like. The “favorite setting enumeration” 43 is the region in which the names of the pieces of printing setting information stored in the HDD 17 as the “favorite settings” are displayed for the selection of the favorite setting to be applied at the time of printing execution. The reference setting selection region 44 is the region in which the names of the pieces of printing setting information selectable as the reference setting are displayed for the selection of the reference setting. The set content display region 45 is the region in which the content of the printing setting information selected in the “favorite setting enumeration” 43 among the pieces of printing setting information stored in the HDD 17 is displayed.

Steps S1-S5 shown in FIG. 9 are the steps for the processing of displaying the editing screen 132 of the favorite settings shown in FIG. 12. First, as shown in FIG. 9, a favorite setting list is obtained from the corresponding registry (see FIG. 3) in the HDD 17 by the control section 11 (Step S1).

Next, the control section 11 displays the obtained favorite setting list on the “favorite setting enumeration” 43 on the editing screen 132 of the favorite settings (Step S2). In the example shown in FIG. 12, “standard setting,” “2 in 1,” “copy protect,” “picture,” “grayscale,” and “user setting 01” are displayed in the “display favorite setting enumeration” 43 as the names of the favorite settings. A user selects any one setting in the “favorite setting enumeration” 43 by an operation of the operation section 12.

Next, the control section 11 obtains the printing setting information selected in the “favorite setting enumeration” 43 from the corresponding registry (see FIG. 4) of the HDD 17 (Step S3).

Next, the control section 11 displays the content of the printing setting information selected in the “favorite setting enumeration” 43 in the set content display region 45 on the editing screen 132 of the favorite settings (Step S4). In the example shown in FIG. 12, the set content display region 45 is configured to be dividedly expressed by the tabs composed of basic setting, layout, finish, cover sheet/insert sheet, stamp/page printing, image quality, and others, and a set value is displayed to each of a plurality of setting items (document orientation, document size, sheet size, zoom, feeding tray, sheet type, and the like) in each tab.

Next, the control section 11 displays the names of the selectable reference settings in the reference setting selection region 44 on the editing screen 132 of the favorite settings (Step S5). In the example shown in FIG. 12, the items of “copy protect,” “2 in 1,” “present setting,” and “standard setting” are displayed in the reference setting selection region 44. The data of the items “copy protect,” “2 in 1,” and “standard setting” in the printing setting information selectable as the reference setting is shared with the favorite settings, and the data is stored in the HDD 17. The item of “present setting” is the printing setting information presently set in the printer driver and is stored in the RAM 16. A user selects any one of the settings in the reference setting selection region 44 with an operation of the operation section 12.

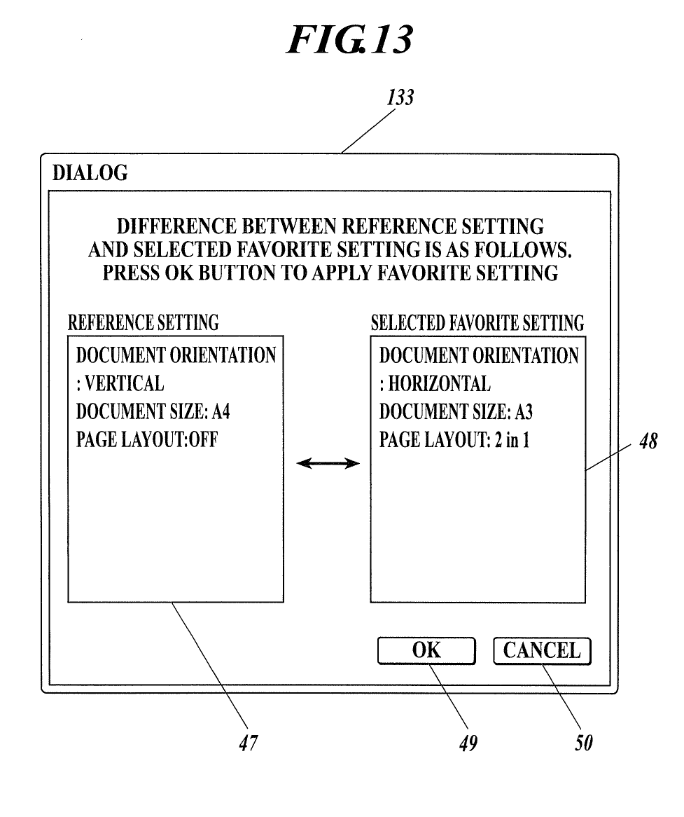

Next, if the OK button 46 is clicked in the editing screen 132 of the favorite settings displayed in the display section 13 with an operation of the mouse in the operation section 12 (Step S6: YES), then the control section 11 displays a, different point displaying screen 133 shown in FIG. 13 in the display section 13. As shown in FIG. 13, the different point displaying screen 133 includes a reference setting displaying region 47, a selected favorite setting displaying region 48, an OK button 49, and a cancel button 50. The reference setting displaying region 47 is the region in which only the setting items of a reference setting that differ from those of a selected favorite setting are displayed. The selected favorite setting displaying region 48 is the region in which only the setting items of the selected favorite setting that differ from those of the reference setting are displayed.

The processing shown at Steps S7-S14 in FIG. 10 is the processing for displaying the different point displaying screen 133 shown in FIG. 13. As shown in FIG. 10, the control section 11 obtains the printing setting information (selected favorite setting) selected in the “favorite setting enumeration” 43 shown in FIG. 12 from the corresponding registry (see FIG. 4) in the HDD 17 (Step S7).

Next, the control section 11 obtains the printing setting information (reference setting) selected in the reference setting selection region 44 shown in FIG. 12 from the corresponding registry (see FIG. 4) of the HDD 17 or the RAM 16 (Step S8). To put it concretely, if the setting other than the “present setting” is selected in the reference setting selection region 44, then the control section 11 obtains the printing setting information from the corresponding registry of the HDD 17. If the “present setting” is selected in the reference setting selection region 44, then the presently set printing setting information is obtained from the RAM 16.

Next, with respect to the first setting item, the control section 11 compares the selected favorite setting and the reference setting with each other (Step S9). If the selected favorite setting and the reference setting do not agree with each other with respect to the setting item of the comparison object (Step S10: NO), then the setting item, and the set content of the selected favorite setting and the reference setting is held in the RAM 16 by the control section 11 (Step S11).

After the processing at Step S11, or if the selected favorite setting and the reference setting agree with each other with respect to the setting item of the comparison object at Step S10 (Step S10: YES), then the control section 11 judges whether the comparison of the selected favorite setting and the reference setting with each other has ended to all the items or not (Step S12).

If the comparison of the selected favorite setting and the reference setting with each other has not ended to all the items (Step S12: NO), then the selected favorite setting and the reference setting are compared with each other with respect to the next setting item (Step S13), and the processing at Steps S10-S12 is repeated.

If the comparison of the selected favorite setting and the reference setting with each other is judged to have ended with respect to all the items at Step S12 (Step S12: YES), then as shown in FIG. 13, the control section 11 displays the different point displaying screen 133 showing the different points between the selected favorite setting and the reference setting held in the RAM 16 in the display section 13 (Step S14). The control section 11 displays only the setting items of the reference setting that are different from those of the selected favorite setting in the reference setting displaying region 47, and displays only the setting items of the selected favorite setting that differ from those of the reference setting in the selected favorite setting displaying region 48.

In the example of the different point displaying screen 133 shown in FIG. 13, the setting items of the reference setting different from those of the selected favorite setting are “document orientation,” “document size,” and “page layout.” Each of the setting items are set in the reference setting to “vertical,” “A4,” and “OFF,” but contrarily each the setting items are set in the selected favorite setting are set to “horizontal,” “A3,” and “2 in 1.”

Next, the control section 11 judges whether the OK button 49 is clicked or whether the cancel button 50 is clicked in the different point displaying screen 133 by a user's operation of the operation section 12 (Step S15). If the OK button 49 is clicked on the different point displaying screen 133 (Step S15: OK), then the control section 11 sets the selected favorite setting on the RAM 16 as the present setting (Step S16). That is, the selected favorite setting is applied at the time of printing execution.

On the other hand, the cancel button 50 is clicked in the different point displaying screen 133 (Step S15: Cancel), then the selected favorite setting is not applied, and the processing ends as it is.

As described above, according to the PC 10 of the first embodiment, the printing setting information to be applied at the time of printing execution selected through the operation section 12 is obtained from the HDD 17, and the selected favorite setting and the reference setting are compared with each other in each of the setting items. Then, the information indicating the differences between the selected favorite setting and the reference setting is recognizably displayed in the display section 13. Consequently, at the time of selecting the printing setting information to be applied at the time of printing execution from the plurality of pieces of printing setting information stored in the HDD 17 in advance, the differences of the selected printing setting information from the reference setting can be informed. Consequently, the changes of settings that a user does not intend can be prevented.

Moreover, since only the setting items where the selected favorite setting and the reference setting are different from each other among the setting items of the selected favorite setting and the reference setting are displayed in the display section 13 as the information indicating the differences between the selected favorite setting and the reference setting, a user can easily recognize the differences between the selected favorite setting and the reference setting.

Moreover, since a user can also select the reference setting, the differences between the selected favorite setting and the reference setting that the user has arbitrarily selected can be informed. Moreover, by selecting the standard setting or a present setting as the reference setting, the differences of the selected favorite setting from the standard setting and the present setting can be informed.

Moreover, after a user has recognized the differences between the selected favorite setting and the reference setting, it can be selected whether the selected favorite setting is applied at the time of printing execution or not.

### [Variation 1]

Next, a variation 1 of the first embodiment will be described.

Since the image forming system of the variation 1 has similar configuration to that of the image forming system 100 shown as the first embodiment, the same components of the variation 1 as those of the image forming system 100 are denoted by the same reference numbers, and the illustration and description of the same components are omitted. Hereinafter, the characteristic configuration and processing of the variation 1 will be described.

Although in the first embodiment the first printing setting processing is executed when the editing button 41 is clicked on the printing setting screen 131 shown in FIG. 11, in the variation 1, the different point displaying screen 133 shown in FIG. 13 is displayed when any of favorite settings is selected in a favorite selecting region 42 on the printing setting screen 131 by an operation of the mouse of the operation section 12. The favorite selecting region 42 is the region for selecting any piece of printing setting information among the pieces of printing setting information stored in the HDD 17 as the “favorite setting” by means of a pull-down menu.

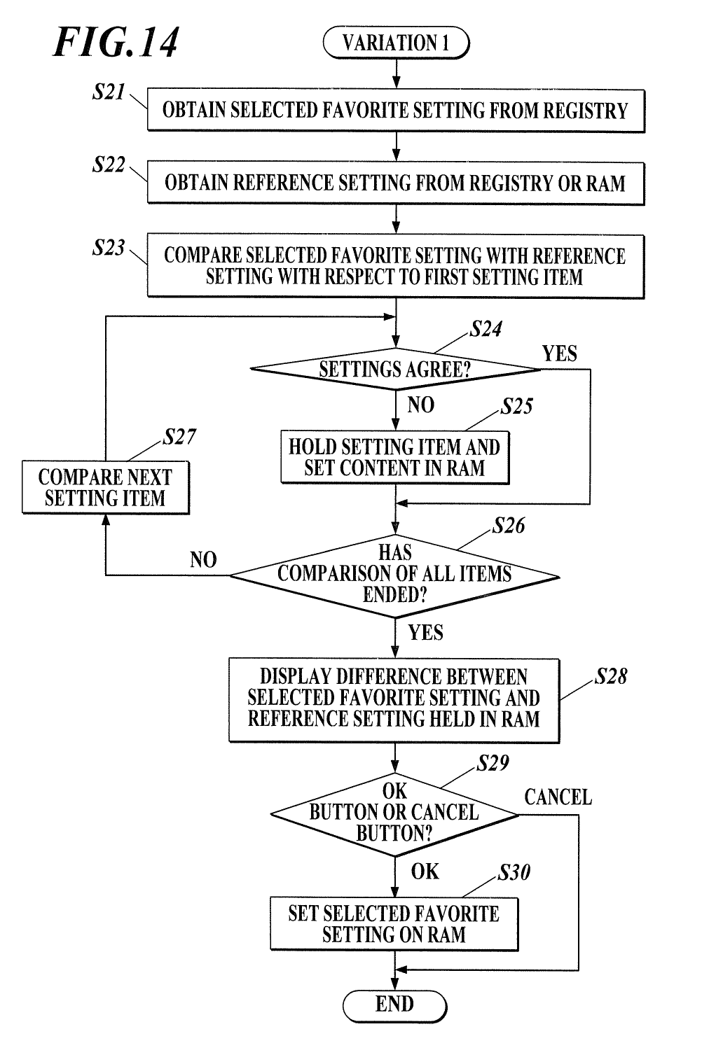

FIG. 14 is a flow chart showing the printing setting processing in the variation 1 executed in the PC 10. The processing is realized by the software processing by the corporation of the CPU of the control section 11 and the printer driver program stored in the HDD 17.

As shown in FIG. 14, the control section 11 obtains the printing setting information (selected favorite setting) selected in the favorite selecting region 42 on the printing setting screen 131 shown in FIG. 11 from the corresponding registry (see FIG. 4) in the HDD 17 (Step S21).

Next, the control section 11 obtains the printing setting information of the reference setting from the corresponding registry (see FIG. 4) of the HDD 17 or the RAM 16 (Step S22). To put it concretely, if the reference setting is setting other than the “present setting”, then the control section 11 obtains printing setting information from the corresponding registry of the HDD 17. If the reference setting is the “present setting,” then the presently set printing setting information is obtained from the RAM 16.

Next, with respect to the first setting item, the control section 11 compares the selected favorite setting and the reference setting with each other (Step S23). In the following, the processing from Step S24-S30 is similar to the processing from Step S10-S16 shown in FIG. 10, the description thereof is omitted.

In the variation 1, the different point displaying screen 133 (see FIG. 13) indicating the different points between the selected favorite setting and the reference setting can be displayed in response to the selection of the favorite setting in the favorite selecting region 42 on the printing setting screen 131 shown in FIG. 11.

### [Variation 2]

Next, a variation 2 of the first embodiment will be described.

Since the image forming system of the variation 2 has similar configuration to that of the image forming system 100 of the first embodiment, the same components as those of the image forming system 100 are denoted by the same reference numbers as those of the image forming system 100, and the illustration and description of the same components are omitted. Hereinafter, the characteristic configurations and processing of the variation 2 will be described.

In the variation 2, the help information of each of the setting items PC 10 is stored in the HDD 17. The control section 11 provides the link to help information with respect to each setting item at the time of displaying the setting items where the selected favorite setting and the reference setting are different from each other in the display section 13, and the control section 11 reads the help information of the corresponding setting item from the HDD 17 to display the read help information in the display section 13 on the basis of a user's operation of the operation section 12.

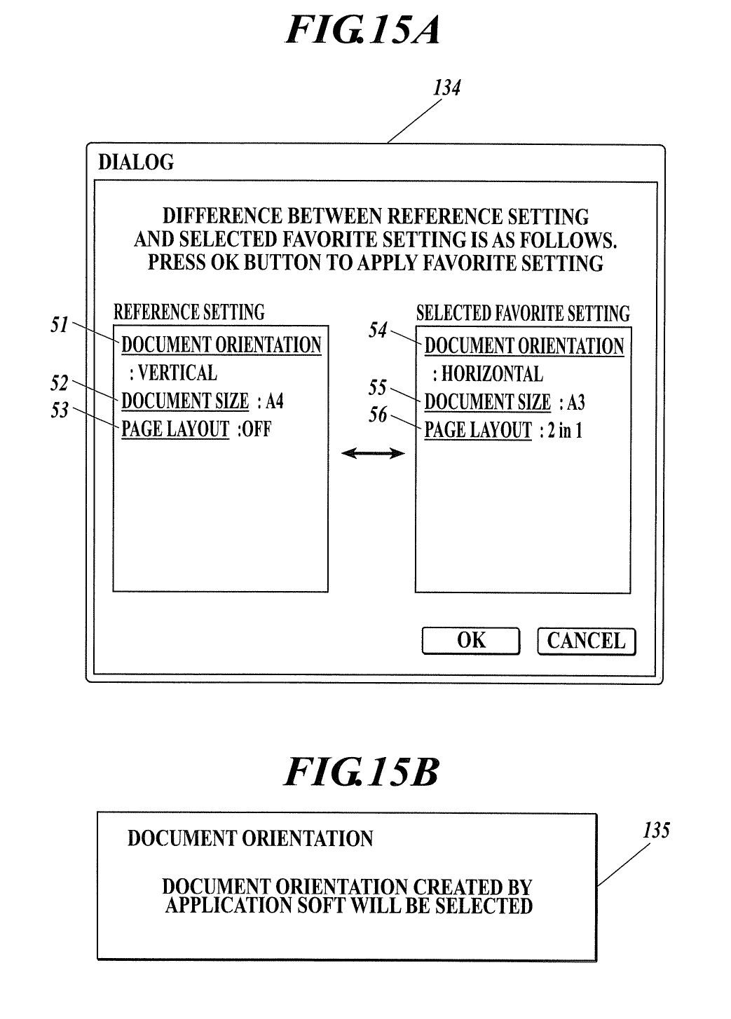

FIG. 15A shows an example of a different point displaying screen 134 showing different points between a selected favorite setting and a reference setting. The processing until displaying the different point displaying screen 134 is similar to that until the first embodiment displays the different point displaying screen 133 (see FIG. 13) (Steps S7-S14 shown in FIG. 10). Links for displaying help information are provided to each of the setting items 51, 52, 53, 54, 55, and 56 in the different point displaying screen 134.

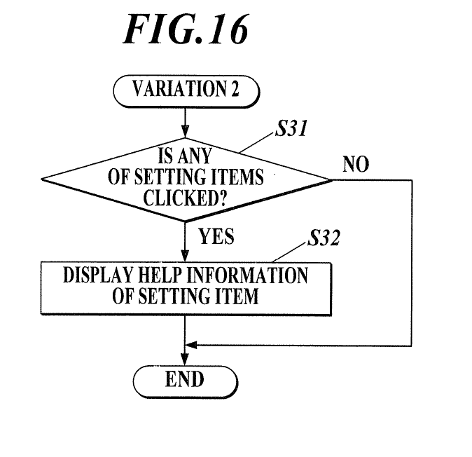

FIG. 16 is a flow chart showing the help display processing in the variation 2 executed by the PC 10. The processing is realized by the software processing by the corporation of the CPU of the control section 11 with the printer driver program stored in the HDD 17.

As shown in FIG. 16, if any of the setting items 51, 52, 53, 54, 55, and 56 is clicked on the different point displaying screen 134 shown in FIG. 15A by a user's operation of the operation section 12 (Step S31: YES), then the control section 11 obtains the help information of the corresponding setting item from the HDD 17, and the obtained help information is displayed in the display section 13 by a pop-up display (Step S32).

FIG. 15B shows an example of a help screen 135, which is displayed in the case where the setting item 51 or the setting item 54 is clicked on the different point displaying screen 134. On the help screen 135, the help information with respect to the “document orientation” is displayed.

In the variation 2, by displaying the help information of a setting item, it is possible to inform which content is changed.

### Second Embodiment

Next, a second embodiment of the present invention will be described.

Since the image forming system of the second embodiment has a similar configuration to that of the image forming system 100 shown in the first embodiment, the same components as those of the image forming system 100 are denoted by the same reference numbers as those of the image forming system 100, and he illustration and description of the components are omitted. In the following, the characteristic configurations and processing of the second embodiment will be described.

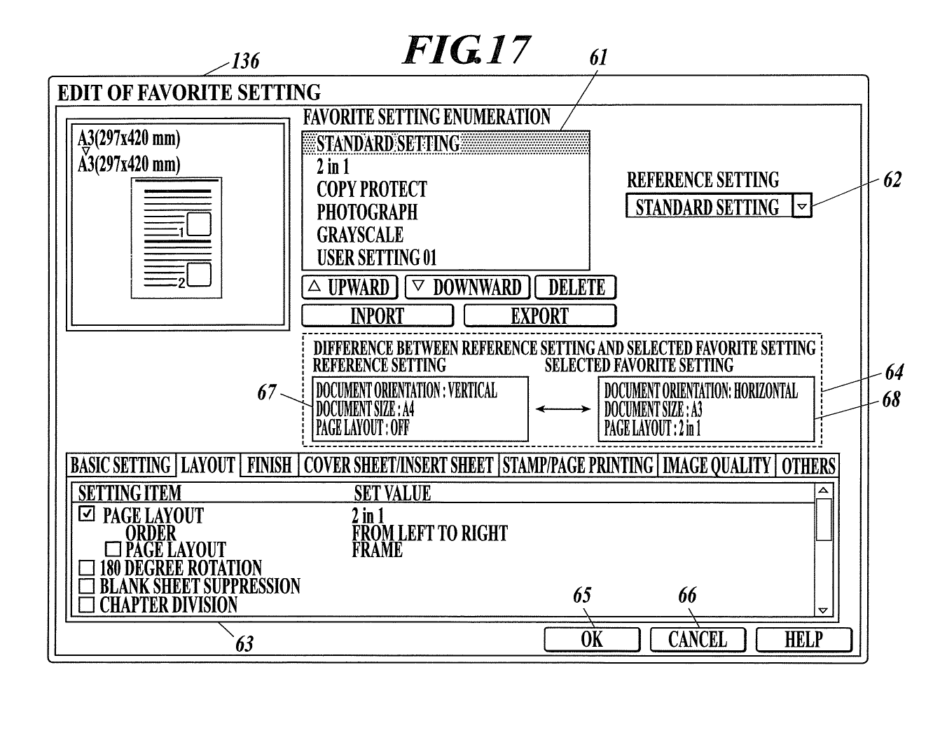

In the second embodiment, when the editing button 41 is clicked on the printing setting screen 131 shown in FIG. 11 by an operation of the mouse in the operation section 12, an editing screen 136 of favorite settings shown in FIG. 17 is displayed in the display section 13. As shown in FIG. 17, the editing screen 136 of the favorite settings includes a “favorite setting enumeration” 61, a reference setting selection region 62, a set content displaying region 63, a different point displaying region 64, an OK button 65, a cancel button 66, and the like. The “favorite setting enumeration” 61 is the region in which the names of pieces of printing setting information stored in the HDD 17 as the “favorite settings” are displayed for selecting the favorite setting to be applied at the time of printing execution. The reference setting selection region 62 is the region in which the names of the pieces of printing setting information selectable as a reference setting for selecting the reference setting. The set content display region 63 is the region in which the content of the printing setting information selected in the “favorite setting enumeration” 61 among pieces of the printing setting information stored in the HDD 17 is displayed. The different point displaying region 64 is the region in which the different points between a, selected favorite setting and a reference setting are displayed.

Although in the first embodiment the different point displaying screen 133 shown in FIG. 13 is displayed besides the editing screen 132 of favorite settings shown in FIG. 12, in the second embodiment, the different points between a selected favorite setting and a reference setting are displayed in the different point displaying region 64 in the editing screen 136 of the favorite settings.

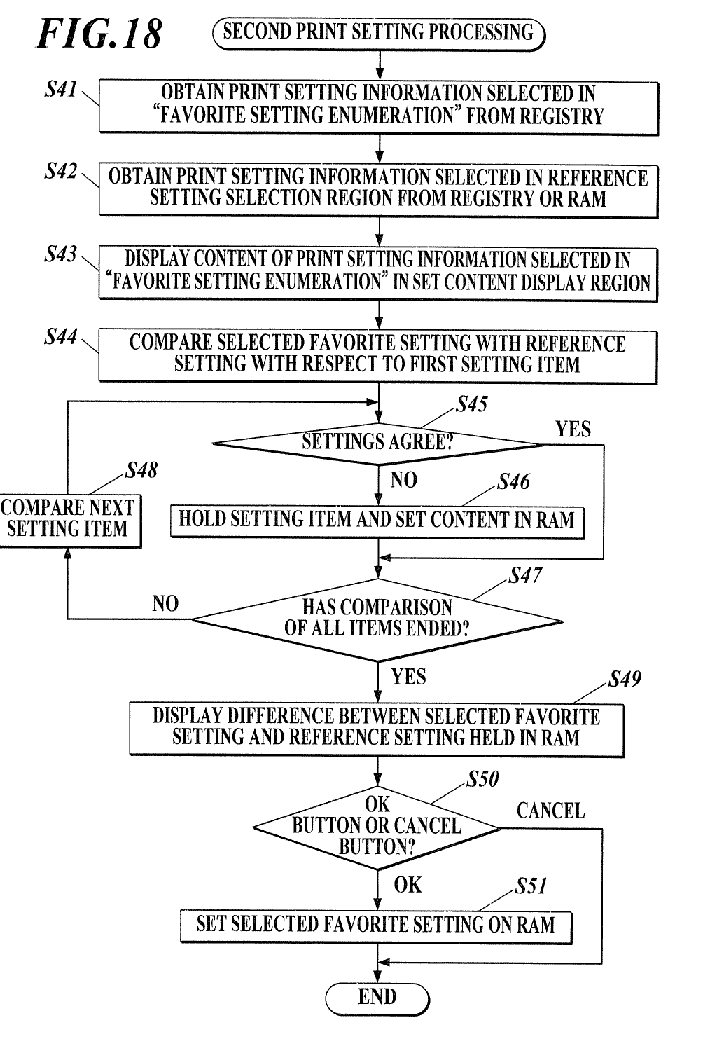

FIG. 18 is a flow chart showing the second printing setting processing executed in the PC 10. The processing is the processing to be executed when a favorite setting is changed in the “favorite setting enumeration” 61 on the editing screen 136 of the favorite settings shown in FIG. 17, or when a reference setting is reselected in the reference setting selection region 62, and is realized by the software processing by the corporation of the CPU of the control section 11 and the printer driver program stored in the HDD 17.

First, as shown in FIG. 18, the control section 11 obtains the printing setting information (selected favorite setting) selected in the “favorite setting enumeration” 61 shown in FIG. 17 from the corresponding registry (see FIG. 4) of the HDD 17 (Step S41).

Next, the control section 11 obtains the printing setting information (reference setting) selected in the reference setting selection region 62 shown in FIG. 17 from the corresponding registry (see FIG. 4) of the HDD 17 or the ROM 16 (Step S42). To put it concretely, if the setting other than the “present setting” is selected in the reference setting selection region 62, then the control section 11 obtains the printing setting information from the corresponding registry of the HDD 17, and if the “present setting” is selected in the reference setting selection region 62, then the control section 11 obtains the presently set printing setting information from the RAM 16.

Next, the control section 11 displays the content of the printing setting information selected in the “favorite setting enumeration” 61 shown in FIG. 17 in the set content display region 63 on the editing screen 136 of the favorite settings (Step S43).

Next, with respect to the first setting item, the control section 11 compares the selected favorite setting and the reference setting with each other (Step S44). If the selected favorite setting and the reference setting do not agree with each other with respect to the setting item of the comparison object (Step S45: NO), then the setting item, and the set content of the selected favorite setting and the reference setting are held in the RAM 16 by the control section 11 (Step S46).

After Step S46, or if the selected favorite setting and the reference setting agree with each other with respect to the setting item of the comparison object at Step S45 (Step S45: YES), then the control section 11 judges whether the comparison of the selected favorite setting and the reference setting with each other has ended to all the items or not (Step S47).

If the comparison of the selected favorite setting and the reference setting with each other has not ended to all the items (Step S47: NO), then the selected favorite setting and the reference setting are compared with each other to the next setting item (Step S48), and the processing at Step S45-Step S47 is repeated.

If the comparison of the selected favorite setting and the reference setting with each other has ended to all the items at Step S47 (Step S47: YES), then the control section 11 displays the different points between the selected favorite setting and the reference setting held in the RAM 16 in the different point displaying region 64 on the editing screen 136 of the favorite settings (Step S49). The different point displaying region 64 includes a reference setting displaying region 67 and a selected favorite setting displaying region 68. The control section 11 displays only the setting items of the reference setting that are different from the those of the selected favorite setting in the reference setting are displayed in the reference setting displaying region 67, and displays only the setting items of the selected favorite setting that are different from those of the reference setting in the selected favorite setting are displayed in the selected favorite setting displaying region 68.

Next, the control section 11 judges whether either of an OK button 65 and a cancel button 66 is clicked or not on the editing screen 136 of the favorite settings by a user's operation of the operation section 12 (Step S50). If the OK button 65 is clicked on the editing screen 136 of the favorite settings (Step S50: OK), the control section 11 sets the selected favorite setting on the RAM 16 as the present setting (Step S51). That is, the selected favorite setting is applied at the time of printing execution.

On the other hand, if the cancel button 66 is clicked on the editing screen 136 of the favorite settings (Step S50: Cancel), then the selected favorite setting is not applied, and the processing ends as it is.

As described above, according to the PC 10 in the second embodiment, the printing setting information to be applied at the time of printing execution, which printing setting information has been selected through the operation section 12, is obtained from the HDD 17, and the selected favorite setting and the reference setting are compared with each other to each of the setting items. Then, the information indicating the difference between the selected favorite setting and the reference setting is recognizably displayed in the display section 13, and consequently at the time of selecting a piece of printing setting information to be applied at the time of printing execution from a plurality of pieces of printing setting information stored in the HDD 17 already, the difference of the selected printing setting information from the reference setting can be informed. Consequently a change of setting that a user does not intend can be prevented.

Moreover, as the information indicating the differences between the selected favorite setting and the reference setting, the setting items that are different between the selected favorite setting and the reference setting among setting items of the selected favorite setting and reference setting are displayed in the display section, and consequently a user can easily recognize the differences between the selected favorite setting and the reference setting.

### Third Embodiment

Next, a third embodiment of the present invention will be described.

The image forming system of the third embodiment has a similar configuration to that of the image forming system 100 shown in the first embodiment, and accordingly the same components as those of the first embodiment are denoted by the same reference numbers as those of the first embodiment. The illustration and description of the same components are omitted. In the following, the characteristic configurations and processing of the third embodiment will be described.

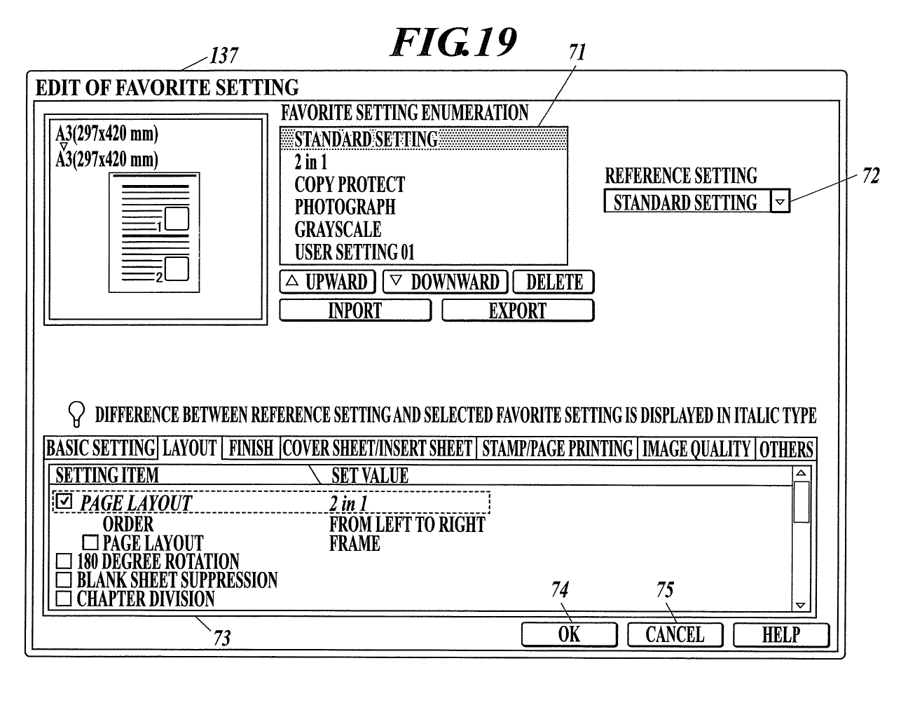

In third embodiment, when the editing button 41 is clicked on the printing setting screen 131 shown in FIG. 11 by an operation of the mouse in the operation section 12, then the editing screen 137 of the favorite settings shown in FIG. 19 is displayed in the display section 13. As shown in FIG. 19, the editing screen 137 of the favorite settings includes a “favorite setting enumeration” 71, a reference setting selection region 72, a set content display region 73, and OK button 74, a cancel button 75, and the like. The “favorite setting enumeration” 71 is the region in which the names of pieces of printing setting information stored in the HDD 17 as the “favorite settings” are displayed for selecting the favorite setting to be applied at the time of printing execution. The reference setting selection region 72 is the region in which the names of the pieces of printing setting information selectable as a reference setting for selecting the reference setting. The set content display region 73 is the region in which the content of the printing setting information selected in the “favorite setting enumeration” 43 among pieces of the printing setting information stored in the HDD 17 is displayed.

The control section 11 recognizably displays the information indicating the differences between the selected favorite setting and a reference setting in the display section 13. To put it concretely, the control section 11 displays the selected favorite setting in the display section 13 by highlighting the setting items of the selected favorite setting that are different from those of the reference setting as the information indicating the differences between the selected favorite setting and the reference setting. As the method of displaying a certain setting item with a highlight, for example, changing the style of type, changing the color of a letter, changing the size of a letter, and the like can be given, but any method may be used as long as the method can discriminate a letter from the others.

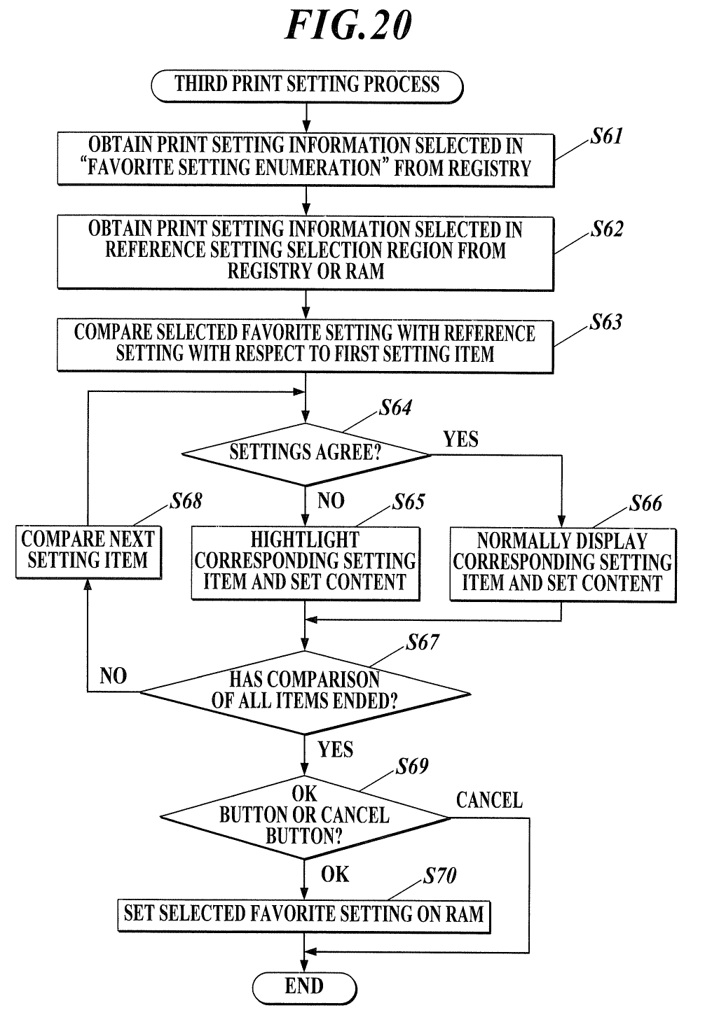

FIG. 20 is a flow chart showing the third printing setting processing executed in the PC 10. The processing is the processing to be executed when a favorite setting is changed in the “favorite setting enumeration” 71 on the editing screen 137 of the favorite settings shown in FIG. 19, or when a reference setting is reselected in the reference setting selection region 72, and is realized by the software processing by the corporation of the CPU of the control section 11 and the printer driver program stored in the HDD 17.

First, as shown in FIG. 20, the control section 11 obtains the printing setting information selected in the “favorite setting enumeration” 71 shown in FIG. 19 is obtained from the corresponding registry (see FIG. 4) of the HDD 17 (Step S61).

Next, the control section 11 obtains the printing setting information selected in the reference setting selection region 72 shown in FIG. 19 from the corresponding registry (see FIG. 4) of the HDD 17 or the ROM 16 (Step S62). To put it concretely, if the setting other than the “present setting” is selected in the reference setting selection region 72, then the control section 11 obtains the printing setting information from the corresponding registry of the HDD 17, and if the “present setting” is selected in the reference setting selection region 72, then the control section 11 obtains the presently set printing setting information from the RAM 16.

Next, with respect to the first setting item, the control section 11 compares the selected favorite setting and the reference setting with each other (Step S63). If the selected favorite setting and the reference setting do not agree with each other with respect to the setting item of the comparison object (Step S64: NO), then the control section 11 highlights the corresponding setting item, and the set content of the selected favorite setting to display them in the set content display region 73 on the editing screen 137 of the favorite settings (Step S65). In the example shown in FIG. 19, the setting item “page layout” and the set value “2 in 1” are displayed to be italicized in the set content display region 73 on the editing screen 137 of the favorite settings. That is, it is displayed that the set content pertaining to the “page layout” is different from that of the reference setting in the selected favorite setting.

On the other hand, if the selected favorite setting and the reference setting agree with each other with respect to the setting item of the comparison object (Step S64: YES), then the control section 11 normally displays the corresponding setting item and the set content of the selected favorite setting in the set content display region 73 on the editing screen 137 of the favorite settings (Step S66).

After Step S65 or S66, the control section 11 judges whether the comparison of the selected favorite setting and the reference setting with each other has ended to all the items or not (Step S67).

If the comparison of the selected favorite setting and the reference setting with each other has not ended to all the items (Step S67: NO), then the selected favorite setting and the reference setting are compared with each other to the next setting item (Step S68), and the processing at Step S64-Step S67 is repeated.

If the comparison of the selected favorite setting and the reference setting with each other has ended to all the items at Step S47 (Step S67: YES), then the control section 11 judges which of an OK button 74 and a cancel button 75 is clicked on the editing screen 137 of the favorite settings by a user's operation of the operation section 12 (Step S69). If the OK button 74 is clicked on the editing screen 137 of the favorite settings (Step S69: OK), the control section 11 sets the selected favorite setting on the RAM 16 as the present setting (Step S70). That is, the selected favorite setting is applied at the time of printing execution.

On the other hand, if the cancel button 66 is clicked on the editing screen 137 of the favorite settings (Step S69: Cancel), then the selected favorite setting is not applied, and the processing ends as it is.

As described above, according to the PC 10 in the third embodiment, the printing setting information to be applied at the time of printing execution, which printing setting information has been selected through the operation section 12, is obtained from the HDD 17, and the selected favorite setting and the reference setting are compared with each other to each of the setting items. Then, the information indicating the difference between the selected favorite setting and the reference setting is recognizably displayed in the display section 13, and consequently at the time of selecting a piece of printing setting information to be applied at the time of printing execution from a plurality of pieces of printing setting information stored in the HDD 17 already, the difference of the selected printing setting information from the reference setting can be informed. Consequently a change of setting that a user does not intend can be prevented.

Moreover, since the selected favorite setting is displayed in the display section 13 by highlighting the setting items of the selected favorite setting different from those of the reference setting, a user can easily recognize the differences between the selected favorite setting and the reference setting.

Incidentally, the description in each of the embodiments mentioned above are the examples of the printing instructing apparatus according to the present invention, and the present invention is not limited to the description. The configurations and operations of the details of each part constituting the apparatus can be suitably changed without departing from the sprit and scope of the present invention.

For example, in the each of the aforesaid embodiments, the case where the printing setting information to be applied at the time of printing execution in the image forming apparatus 20 is selected on the printer driver of the PC 10, and where a printing instruction (print job) is transmitted from the PC 10 to the image forming apparatus 20 has been described. However, the printing setting information with respect to each of a plurality of setting items may be stored in the storage section 29 of the image forming apparatus 20 in advance, and the information indicating the differences between the printing setting information and the reference printing setting information selected from the operation section 22 of the image forming apparatus 20 may be recognizably displayed in the display section 23 of the image forming apparatus 20.

Moreover, also in the PC 10 of each of the second embodiment and the third embodiment, the help information of a setting item may be displayed in the display section 13 with respect to the setting item that are different in the selected favorite setting and in the reference setting as the variation 2 of the first embodiment.

In the above description, the examples using the ROM or HDD as the computer readable medium storing the programs for executing each processing have been disclosed, but the present invention is not limited to the examples. As other computer readable media, non-volatile memories such as a flash memory, and portable recording media such as a CD-ROM, can be applied. Moreover, as media for providing the data of programs through communication lines, carrier waves may be applied.

According to a preferable aspect of the present invention, there is provided a printing instructing apparatus to instruct printing in an image forming apparatus, which includes: a storage section to store a plurality of pieces of printing setting information with respect to each of a plurality of setting items; a display section; an operation section to receive a selection of a piece of printing setting information to be applied at the time of printing execution among the plurality of pieces of printing setting information stored in the storage section; and a control section to obtain the selected printing setting information from the storage section, to compare the selected printing setting information and the reference printing setting information with each other with respect to each of the setting items, and to recognizably display information indicating a difference between the selected printing setting information and the reference printing setting information in the display section.

In the printing instruction apparatus, it is possible to inform the difference between the printing setting information to be applied at the time of printing execution and the reference printing setting information at the time of selecting the printing setting information from the plurality of pieces of printing setting information stored already.

Preferably, in the printing instructing apparatus, the control section displays in the display section only a setting item where the selected printing setting information and the reference printing setting information are different from each other among the setting items of the selected printing setting information and the reference printing setting information as the information indicating the difference between the selected printing setting information and the reference printing setting information.

The printing instructing apparatus displays only the setting items where the selected printing setting information and the reference printing setting information are different from each other among the setting items of the selected printing setting information and the reference printing setting information, and consequently the difference between the selected printing information and the reference printing setting information becomes easily recognized.

Preferably, in the printing instructing apparatus, the control section displays the selected printing setting information in the display section by highlighting a setting item where the selected printing setting information and the reference printing setting information are different from each other as the information indicating the difference between the selected printing setting information and the reference printing setting information.

Since the printing instructing apparatus displays the selected printing setting information by highlighting the setting item where the selected printing setting information and the reference printing setting information are different from each other, the difference between the selected printing setting information and the reference printing setting information becomes easily recognized.

Furthermore preferably, in the printing instructing apparatus, the reference printing setting information is selected by a user.

In the printing instructing apparatus, the difference between the selected printing setting information and the reference printing setting information that the user selects can be informed.

Furthermore preferably, in the printing instructing apparatus, the reference printing setting information is previously determined standard printing setting information.

In the printing instructing apparatus, the difference between the selected printing setting information and the standard printing setting information can be informed.

Furthermore preferably, in the printing instructing apparatus, the reference printing setting information is presently set printing setting information.

In the printing instructing apparatus, the difference between the selected printing setting information and the presently set printing setting information can be informed.

Furthermore preferably, in the printing instructing apparatus, the operation section further receives a selection of whether to apply the selected printing setting information at the time of the printing execution or not, and the control section judges whether to apply the selected printing setting information at the time of the printing execution or not on the basis of an operation of the operation section after displaying the information indicating the difference between the selected printing setting information and the reference printing setting information recognizably in the display section.

In the printing instructing apparatus, after a user has recognized the difference between the selected printing setting information and the reference printing setting information, the user can select whether to apply the selected printing setting information at the time of printing execution or not.

Furthermore preferably, in the printing instructing apparatus, the control section displays help information of a setting item where the selected printing setting information and the reference printing setting information are different from each other in the display section.

In the printing instructing apparatus, it can be informed which content is changed by displaying the help information of the setting item.

Moreover, according to another preferable aspect of the present invention, there is provided a printing instructing method for instructing printing in an image forming apparatus, which includes the steps of: obtaining printing setting information to be applied at the time of printing execution, the printing setting information being selected by an operation of an operation section, from a storage section storing a plurality of pieces of printing setting information with respect to each of a plurality of setting items; comparing the selected printing setting information and the reference printing setting information with each other with respect to each of the setting items; and displaying information indicating a difference between the selected printing setting information and the reference printing setting information in a display section recognizably.

In the printing instructing method, the difference between the selected printing setting information and the reference printing setting information can be informed at the time of selecting the printing setting information to be applied at the time of the printing execution from the plurality of pieces of printing setting information stored already.

Moreover, according to another preferable aspect of the present invention, there is provided a computer readable recording medium storing a program enabling a computer for instructing printing in an image forming apparatus to realize the following functions: the function of obtaining printing setting information to be applied at the time of printing execution, the printing setting information being selected by an operation of an operation section, from a storage section storing a plurality of pieces of printing setting information with respect to each of a plurality of setting items; the function of comparing the selected printing setting information and the reference printing setting information with each other with respect to each of the setting items; and the function of displaying information indicating a difference between the selected printing setting information and the reference printing setting information in a display section recognizably.

In the recording mediums the difference between the selected printing setting information and the reference printing setting information can be informed at the time of selecting the printing setting information to be applied at the time of the printing execution from the plurality of pieces of printing setting information stored already.

What is claimed is:

1. A printing instructing apparatus to instruct printing in an image forming apparatus, the printing instructing apparatus comprising:
a storage section to store a plurality of pieces of printing setting information, each piece of the printing setting information including a plurality of printing conditions regarding a plurality of setting items, respectively;
a display section;
an operation section to receive a selection of a piece of printing setting information to be applied at the time of printing execution among the plurality of pieces of printing setting information stored in the storage section; and
a control section to obtain the selected printing setting information from the storage section, to respectively compare the printing conditions of the setting items in the selected printing setting information with those in reference printing setting information, and to recognizably display information indicating a difference between the selected printing setting information and the reference printing setting information in the display section.

2. The printing instructing apparatus according to claim 1, wherein the control section displays in the display section only a setting item where the selected printing setting information and the reference printing setting information are different from each other among the setting items of the selected printing setting information and the reference printing setting information as the information indicating the difference between the selected printing setting information and the reference printing setting information.

3. The printing instructing apparatus according to claim 1, wherein the control section displays the selected printing setting information in the display section by highlighting a setting item where the selected printing setting information and the reference printing setting information are different from each other as the information indicating the difference between the selected printing setting information and the reference printing setting information.

4. The printing instructing apparatus according to claim 1, wherein the reference printing setting information is selected by a user.

5. The printing instructing apparatus according to claim 1, wherein the reference printing setting information is previously determined standard printing setting information.

6. The printing instructing apparatus according to claim 1, wherein the reference printing setting information is presently set printing setting information.

7. The printing instructing apparatus according to claim 1, wherein the operation section further receives a selection of whether to apply the selected printing setting information at the time of the printing execution or not, and
the control section judges whether to apply the selected printing setting information at the time of the printing execution or not on the basis of an operation of the operation section after displaying the information indicating the difference between the selected printing setting information and the reference printing setting information recognizably in the display section.

8. The printing instructing apparatus according to claim 1, wherein the control section displays in the display section help information of a setting item where the selected printing setting information and the reference printing setting information are different from each other.

9. A printing instructing method for instructing printing in an image forming apparatus, the method comprising the steps of:
obtaining printing setting information to be applied at the time of printing execution, the printing setting information being selected by an operation of an operation section, from a storage section storing a plurality of pieces of printing setting information, each piece of the printing setting information including a plurality of printing conditions regarding a plurality of set items, respectively;
respectively comparing the printing conditions of the set items in the selected printing setting information with those in reference printing setting information; and
displaying information indicating a difference between the selected printing setting information and the reference printing setting information in a display section recognizably.

10. A computer readable recording medium storing a program enabling a computer for instructing printing in an image forming apparatus to realize the functions of:
obtaining printing setting information to be applied at the time of printing execution, the printing setting information being selected by an operation of an operation section, from a storage section storing a plurality of pieces of printing setting information, each piece of the printing setting information including a plurality of printing conditions regarding a plurality of set items, respectively;
respectively comparing the printing conditions of the set items in the selected printing setting information with those in reference printing setting information; and
displaying information indicating a difference between the selected printing setting information and the reference printing setting information in a display section recognizably.
